(19) United States
(12) Patent Application Publication
(10) Pub. No.: US 2013/0057571 A1
(43) Pub. Date: Mar. 7, 2013

(54) Display Orientation Control

(71) Applicant: John Harris, Glenview, IL (US)

(72) Inventor: John Harris, Glenview, IL (US)

(73) Assignee: Nokia Siemens Networks Oy

(21) Appl. No.: 13/224,618

(22) Filed: Sep. 2, 2011

(51) Int. Cl. G09G 5/00

(52) U.S. Cl. 345/619

(57) ABSTRACT

In accordance with the exemplary embodiments of the invention there is at least a method, apparatus, and computer program code to perform the operations of, determining whether there is a corresponding change of a position of a user of the portable electronic device with respect to the display, and in response to the determining indicating that there is not a corresponding change of the position of the user with respect to the display, maintaining a display orientation of information on the display.

### TECHNICAL FIELD

The teachings in accordance with the exemplary embodiments of this invention relate generally to controlling a display orientation and, more specifically, relate to controlling a display orientation of a device relative to a movement by a user of the device.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Some portable electronic devices are constrained with respect to how they may display information. For example, the device display or screen may be shaped so that it may be more advantageous to display information in one format versus another. Other devices may be configured to show information in either a vertical or horizontal display format based on the general orientation of the device.

If a user of the device does not desire the current display format, such as a display format based on an orientation of the device with respect to ground, the user may, if allowed, change settings on the device in order to change the display to use a desired display format. However, such operations to change the display format can cause significant inconvenience to the user of the device.

### SUMMARY

In an exemplary aspect of the invention, there is a method comprising determining, by a portable electronic device, whether there is a corresponding change of a position of a user of the portable electronic device with respect to a display, and in response to determining there is not a corresponding change of the user with respect to the display, maintaining a display orientation of information on the display.

In an exemplary aspect of the invention, there is an apparatus comprising at least one processor, and at least one memory including computer program code, where the at least one memory and the computer program code are configured, with the at least one processor, to cause the apparatus, to at least determine, by a portable electronic device, whether there is a corresponding change of a position of a user of the portable electronic device with respect to a display, and in response to determining there is not a corresponding change of the user with respect to the display, maintain a display orientation of information on the display.

In another exemplary aspect of the invention, there is an apparatus comprising means for determining, by a portable electronic device, whether there is a corresponding change of a position of a user of the portable electronic device with respect to the display, and means, in response to the determining indicating there is not a corresponding change of the position of the user with respect to the display, for maintaining a display orientation of information on the display.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1A is an exemplary but non-limiting embodiment of a portable electronic device in which aspects of the invention may be practiced to advantage.

FIG. 1B is an exemplary but non-limiting embodiment of an electronic device which includes components of which at least some may be incorporated into an earbud or headset to operate in accordance with the exemplary embodiments of the invention.

FIGS. 2A, 2B, 2C and 2D illustrates scenarios relating to changes of position by a user of a portable electronic device, as well as resulting display orientations of a display of the portable electronic device in accordance with the exemplary embodiments of the invention.

FIG. 3 illustrates a simple block diagram describing a method in accordance with an exemplary embodiment of the invention.

### DETAILED DESCRIPTION

The exemplary embodiments of the invention provide at least a method that can be used to determine an optimum display format of a device using techniques which take into account a position of the user with respect to the display of the device.

In general, a display orientation of some portable electronic devices, such as cellular phones, (e.g., Iphone, iPad) is determined using an accelerometer which outputs a signal such as an inclination detection signal of the portable electronic device with respect to the gravity (or more generally speaking with respect to the ground).

In the conventional art, a portable electronic device may use an accelerometer or multi-axis accelerometer in order to determine a display orientation of a portable electronic device with respect to gravity. Such display orientation can be either a landscape or portrait display orientation. An accelerometer can measure the amount of gravity pull along that particular axis. For example, a multi-axis accelerometer may use three axis of measurement. Either of these types of accelerometer's can provide a basic measurement of the orientation of the device relative to the earth.

More specifically, an accelerometer is a device that measures the type of acceleration associated with weight experienced by at least one mass that resides in a frame of reference of the accelerometer. Further, an accelerometer will measure a value even when sitting on the ground. This is because masses each have a weight, even though they do not change velocity. An accelerometer thus measures weight per unit of mass, also known as a specific force or a g-force. Another way of describing this is that by measuring weight, an accelerometer measures the acceleration of the free-fall reference frame (inertial reference frame) relative to itself.

Using an accelerometer the portable electronic device may set the display orientation of information on the display, such as, to a portrait mode when the portable electronic device is held upright with respect to the ground and to a landscape mode when the portable electronic device is held horizontally or sideways with respect to the ground. However, a problem exists if a user of the portable electronic device does not desire the current display format, such as a display format based on an orientation of the device with respect to ground. The user may, if allowed, change settings on the device in order to change the display to a desired display orientation. However, such operations to change the display orientation of any information on the display can cause significant inconvenience to the user of the device.

The exemplary embodiments of the invention provide at least a method to determine a proper display orientation based on factors in addition to the orientation of the device relative to gravity. These additional factors being detected by the device provide a novel and more intelligent determination of a suitable display orientation for the device.

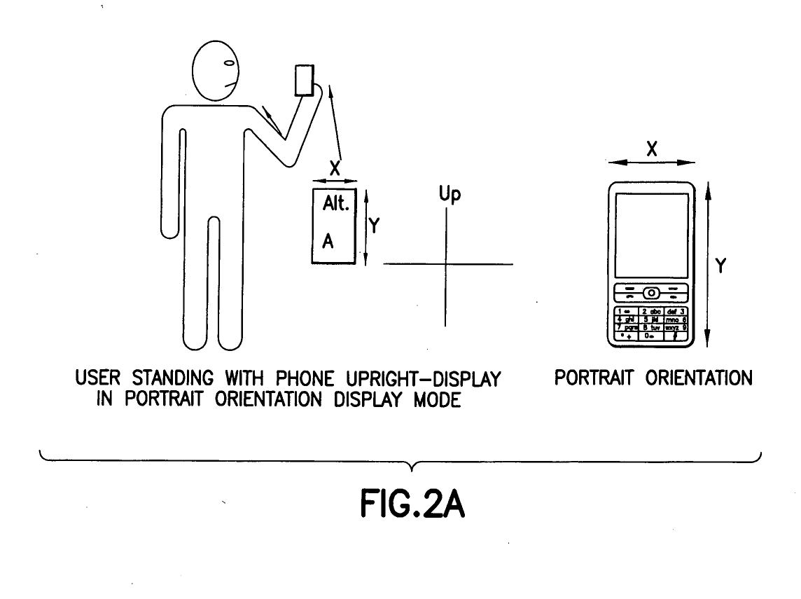

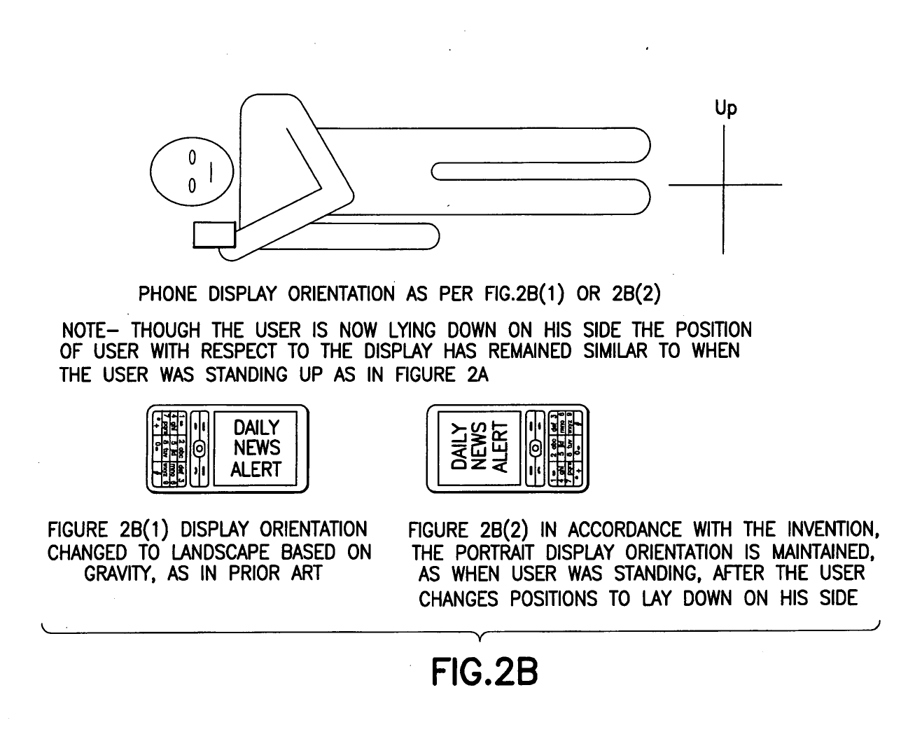

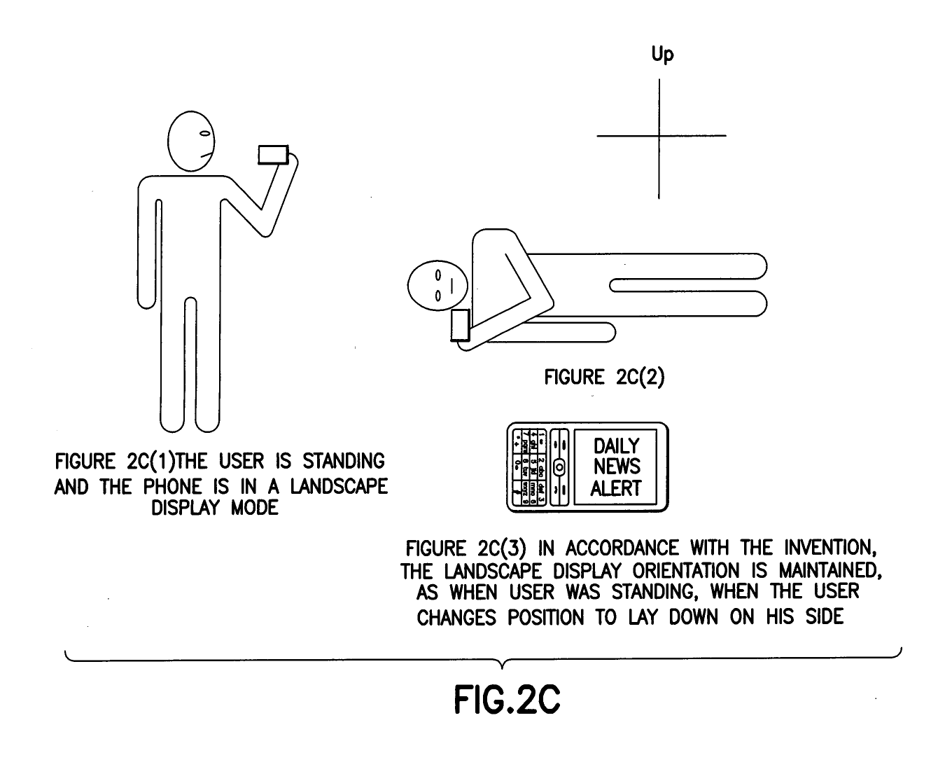

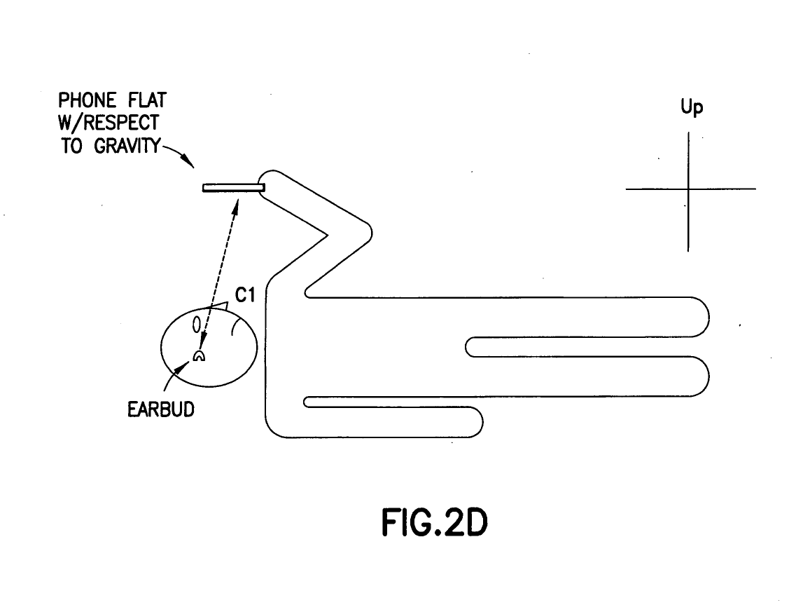

With regards to FIG. 2A, there is illustrated a user is standing with a portable electronic device, hereafter as may be described as a phone. The user in FIG. 2A is holding the phone so that the top of the phone, depicted as X, is up. In this situation the operation of an accelerometer, or other device, of the phone will cause the display to be in a portrait orientation display mode. In the portrait orientation display mode information on the display, such as text and/or images to name, is displayed so that the top of the text and/or images is towards the top of the phone.

Now consider the case, as in FIG. 2B, where the user lays down on his side and is holding the phone in the same way as with respect to when the user was standing, FIG. 2A. In this case, even though the phone display (i.e., the X and Y) has not changed with respect to the user, the side of the phone, as depicted as Y, is now horizontal with respect to the ground. Thus, in the conventional art, the display of the phone will switch to a landscape orientation display mode, as depicted in FIG. 2B(1). This can make it difficult for the user to perceive the text and/or images displayed after the switch from the portrait to the landscape orientation display mode. The exemplary embodiments of the invention, seek to overcome at least this problem.

In accordance with the exemplary embodiments of the invention, when the user lies down from the standing position or vice versa there will be a determination as to whether there is a corresponding change of a position of a user of the portable electronic device with respect to a display. If there is not a corresponding change of the user with respect to the display the display orientation mode will be maintained.

For example, consider the example above where the user, as in FIG. 2A, is standing with the top of the phone, depicted as X, being upright or facing up. Then the user lies down on his side with the phone as in FIG. 2B. In accordance with the embodiments of the invention, there is a determination made as to whether there is a resulting corresponding change of position of the user with respect to a display of the portable electronic device. In this case there is not a corresponding change of position of the user with respect to the display. This is because the top of the device (depicted as X) is the same with respect to the user as was the case when the user was standing up. The top of the phone is still towards the top of the user's head. Therefore, even though the orientation of the display with respect to gravity has changed, the user may not desire that the display to change to a landscape orientation mode as the display did not change with respect to how the user is viewing it. The exemplary embodiments of the invention, provide at least a method which would operate to detect that there is no change of position of the user with respect to the display and, as such, the display will remain in the same mode, for example the portrait orientation display mode, as illustrated in FIG. 2B(2).

As another example, consider FIG. 2C(1) where the user is standing while holding the device so that the side of the device, as depicted as Y, is upright. In this example, the user is standing and viewing the display in a landscape orientation mode. In this landscape orientation mode the top of any text and/or images on the display is towards the wider side, or Y side, of the device. Thus, when the user lies down, as in FIG. 2C(2), the user is still holding the device so that the wide side of the display, or Y side, is towards the top of the user's head. In accordance with the exemplary embodiments, the display will remain in the landscape orientation mode, as in FIG. 2C(3). This is because, as similarly stated above, there is no change of position of the user with respect to the display. It is noted that the description of the display having a wide side and a narrower top is not limiting. The letters X and Y are used for mere illustration purposes. The exemplary embodiments of the invention will operate no matter if the sides of the display or device are wider or narrower, or if the sides of the display or device are different lengths or even the same length.

As would be typical in the conventional art when a user who was similarly standing, as in FIG. 2C(1), is now lying down and the X side of the phone is up with respect to the ground, as in FIG. 2C(2), the display orientation of the device will also change to a portrait orientation mode, and thus create a difficulty for the user viewing the screen. The phone display orientation has switched so that the display orientation of information on the display is length wise (horizontal) on the phone and the top of any information displayed on the screen is towards the ceiling. However, the phone relative to the user's eyes, as if the user were standing, may not have changed. Thus, this change to the display orientation, with respect to the ground, now makes it difficult for the user who is lying down on her side to read/watch the now horizontal display of the phone.

It is noted that the exemplary embodiments of the invention are equally operational whether the device is in a portrait or landscape orientation mode before or after the device is moved. Such as would be a result of a user lying down as illustrated in FIG. 2B from a standing position as illustrated in FIG. 2A. In addition, the movements described herein are not limiting. As such the movements or change of position can include, but are not limited to, a user who is using or holding an electronic device and changing position from standing to lying down, lying down to standing, sitting to lying down, lying down to sitting, lying on one's back to lying on one's side, standing on ones feet to standing on one's head, standing on one's head to standing on one's feet, or any combination thereof. Further, the determinations for the display orientation mode of the device in accordance with the embodiments of the invention can also be used to determine the orientation with which photos or camera images are displayed on a device which has a camera. Including a device which has a second camera which points back at the user who is taking a photo, and/or a device of which the display can be turned around to face the same direction as the primary camera, as is the case with some camcorders for example.

In accordance an exemplary embodiment of the invention, a camera of a device is used in conjunction with an accelerometer or multi-axis accelerometer. The camera is configured to be used to determine a user position with respect to a device. The camera may be used in conjunction with image processing or image object recognition. This image processing may occur in the device itself or possibly in the network. The determination can include whether the user is upright, or whether the user of the device is lying down or in another position relative to the device and/or the display. These determinations can be used to determine if the user's position has changed with respect to the display of the device. If the user is upright the display orientation of the phone will function with respect to the ground, as described above. If it is determined with the camera, that the user of device is lying down on his side or is in another position, then in accordance with the exemplary embodiments the display orientation of the device will be adjusted relative to the user's position with respect to the display, and not based solely on the orientation of the display with respect to gravity/ground.

In accordance with the exemplary embodiments of the invention, the camera of the device could be used to detect a head tilt of a user of the device. The detection operation using the camera can be brief and can be triggered by the device based on certain events, such as events associated with an accelerometer or multi-axis accelerometer of the device. For example, the detection operation using the camera can be performed when the device is at least one of: rotated relative to gravity or relative to the ground, or is facing the sky or directly facing the ground (as is in the case where user is lying on their belly work directly on their back for the compass or camera is needed). Then, the camera operation can be just long enough to obtain the required data. This abbreviated operation with the camera is adjustable in order to conserve battery power and/or memory.

In addition, in accordance with the exemplary embodiments of the invention, the user can adjust or customize the above described camera operation. Such adjusting can be used to obtain more or less data from the camera based on user preference. If the user of the device wishes that the camera provide more detailed information for the display orientation operation then the exposure time or the amount of exposures of the camera can be increased. Or else if the user wishes to keep battery usage to a minimum while benefiting from the camera operation, as described above, then the camera could be set to a minimum amount of exposure time and/or exposures, or the mechanism could be automatically disabled when the remaining battery life is below some predetermined threshold or a threshold set by the user or manufacturer. Further, a video can be taken by the camera, the video triggered by such events as described above. The video being usable for determining movements of the user of the device and providing data for a determination of proper display orientation as in accordance with the exemplary embodiments of the invention. Further, if the device has a flash or other light source then the light source can be configured to be usable with the camera during at least the above described operations if light conditions require it. Additionally, mechanisms of the portable electronic device, which relate to the exemplary embodiments of the invention, could be automatically disabled and/or re-enabled in certain contexts, such as in certain detected locations or when certain image attributes are detected. This feature can be useful for example when the content which would be captured by the camera is of a particularly sensitive nature, such as in a locker room. In one embodiment the camera would be preferably designed such that the image would be deleted almost immediately after an orientation and/or change of orientation of a user of the portable electronic device is determined.

In accordance with the exemplary embodiments of the invention, if a detection operation with the camera provides data which results in a determination that is different than that resulting from a detection operation of an accelerometer or multi-axis accelerometer, compass or a gyroscope of the device, then the data from the camera is used, or given more weight, for any determination regarding a possible change to the display orientation.

In another exemplary embodiment of the invention, if a camera of a device detects two or more different user's faces and/or heads, then, in accordance with the embodiments of the invention, any determinations made will be made using the data derived from the camera with regards to at least one of the face and/or head of the user closest to the camera, the primary user of the device, and/or the user who is most directly looking at the camera. The operation using this feature is user and manufacturer programmable. Further, in accordance with the exemplary embodiments of the invention, the face and/or head of the primary user of the device may be programmed into the device, by the user, using an image of the primary user. The device can use the image to automatically determine if the primary user of the device is in view of the camera or the user can select the primary user for the device. In accordance with the exemplary embodiments, multiple primary users can be assigned for use by the camera of the device. In addition, the configurations described above can be defined for each one of the primary users.

In another exemplary aspect of the invention, an earbud such as, but not limited to, a Bluetooth connected ear bud may be used to provide additional data for the determination of a proper display orientation of a device. The earbud can comprise an accelerometer or multi-axis accelerometer and/or a compass.

In accordance with the exemplary embodiments of the invention, if the accelerometer of the earbud indicates that the ear bud is in a position similar to being, for example, flat on a table then a determination by the device with the data from the ear bud would be that the user of the device is lying down. For example, a determination factor using the ear bud and the accelerometer of the ear bud can be seen to operate as if one were to draw a line directly through the ear bud and passing through the head the line would be parallel with the direction of gravity. Thus, the indication would be that the user of the device is lying down on their side.

Thus, in accordance with the exemplary embodiments of the invention, if the user is lying down on their side as detected with the earbud and/or the camera it is determined that there is not a corresponding change of the user with respect to the display then the handset display should use the “opposite” orientation as is implied by gravity, or relative to ground, as detected by the device accelerometer. This is because although the user has changed position to a lying down position the display orientation of the display with regards to the user still remains in the portrait display mode or the landscape display mode, see FIGS. 2B(2) and 2C(3) respectively, as it was when the user was standing. Note that the opposite of the portrait orientation may be ambiguous as there are two possible landscape orientations possible. In another embodiment the device may select from more than one landscape and portrait orientation. The embodiments of the invention provide a means for selecting between more than one possible landscape and portrait orientation based on at least one of the camera input, the ear bud input, and the orientation used when the user was standing up. In this case the term “opposite” orientation, as stated above, would not be entirely correct as the portable electronic device is able select from more than one possible landscape orientation and more than one possible portrait orientation. Further, it is noted that generally the portrait orientation is more typical used as conventionally the portrait orientation is more closely related to the physical design and features of the device.

In accordance with another exemplary embodiment of the invention, the earbud and/or the device comprises a compass. The compass being used to further enhance the determination of proper display orientation. For example, the earbud and/or the device compass can comprise a solid state compass, a magnetic compass, a dry compass, bearing compass, and/or liquid compass. If the user is lying flat on their back looking at the ceiling while holding the device, such that the display of the device is facing the ground, then determination based on gravity alone does not provide a clear indication of what display orientation is the proper orientation for the user of the device.

Therefore, if the compass is used to determine that the top of device is pointing north, and the determination using the earbud indicates that the top of the earbud is pointing north, then the determination is that a normal portrait orientation, such as with respect to ground, is appropriate. This is because both the user, who is using the earbud, and the top of the device are orientated in the same direction. However, in this case a determination would also need to be made regarding whether the earbud is worn on the left or right ear. This is because when one switches the ear bud from the left or the right ear one essentially turns the earbud upside down. In accordance with the embodiments, the determination of whether the earbud is worn of the left or right ear can be based on a camera image recognition, as described above, or by configuration of the device, or a sensor incorporated therein, or attached to the earbud. Such a sensor can be incorporated in an earbud loop attachment or connected to the earbud loop attachment. The determination of which ear the earbud is in can be based on an adjustment of the ear loop, as the ear loop is typically reversed on the earbud when switched from one ear to the other ear by the user. Further, it is noted that the determination of a left or right ear may not be needed if the user is using a full or both ear headset.

Consider FIG. 2D where the user is lying flat on his back with the phone parallel to the ground. In this case, an accelerometer could not be used by itself to determine whether the display orientation should be in a different portrait mode or horizontal mode. As stated above, an accelerometer in the earbud and/or the camera detects gravity as described above. Thus, in accordance with the exemplary embodiments of the invention, the compass type device is used in both the earbud and the phone. The data from the compass is shared wired or wirelessly, as illustrated with C1, between the earbud and the phone using a communication protocol, such as Bluetooth. The data can be used by the device to determine whether the phone display should be in a portrait or landscape display orientation mode. As one non-limiting example, assume the compass device in the earbud provides an indication that the top of the user's head is directed north and the compass device of the device provides an indication that the top of the device, as illustrated in FIG. 2A as X, is similarly directed north. In this case the display of the device is set to a portrait orientation display mode with the top of the text pointing north. In another non-limiting example, if the compass device of the earbud indicates that the top of the user's head is directed north, and the compass device of the device provides an indication that the top of the device, as illustrated in FIG. 2A as X, is directed west, then the device is set to a landscape orientation display mode with the top of the text pointing north.

It is noted that the portable electronic device as described above is non-limiting. Thus, the portable electronic device can be any mobile electronic device which comprises a display. The exemplary embodiments of the invention may be used to benefit a device such as phone, a smart phone, a tablet, a personal data assistant, an iPhone, iPad, and ebook device, or any portable electronic device which comprises a display. In addition, the earbud described above can be any type of device connected wirelessly or wired to a portable electronic device including a single ear device or headset. Further, the communication for the determinations and/or the display orientation such as between the earbud and the portable electronic device, in accordance with the invention as described above, can be using any hardwire communication protocol or a wireless communication protocol such as any version of Bluetooth.

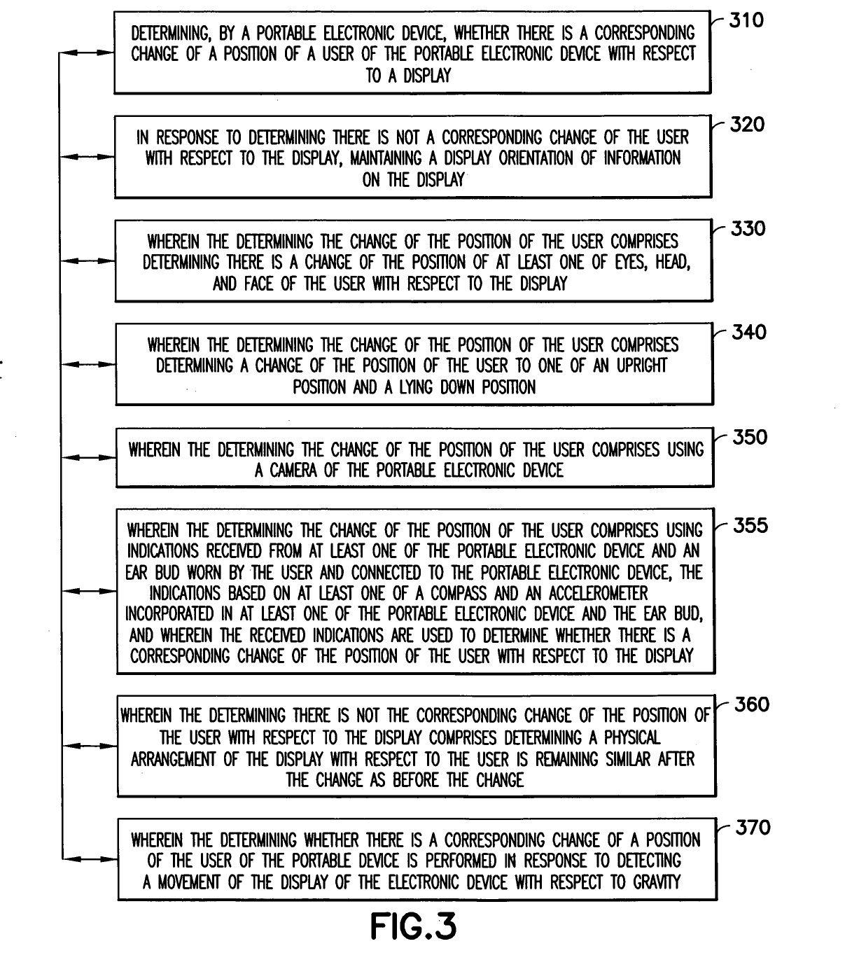

The operations of FIG. 3 can be seen to be from a perspective of the portable electronic device. According to these exemplary embodiments as disclosed herein, at block 310 there is determining, by a portable electronic device, whether there is a corresponding change of a position of a user of the portable electronic device with respect to a display. Then at block 320 there is, in response to determining there is not a corresponding change of the user with respect to the display, maintaining a display orientation of information on the display.

Further details at FIG. 3 summarize various other non-limiting embodiments as detailed at least in the description. Specifically, in FIG. 3 at block 330, wherein the determining the change of the position of the user comprises determining there is a change of position of at least one of eyes, head, and face of the user with respect to the display. Another embodiment is shown at block 340 wherein the determining the change of the position of the user comprises determining a change of the position of the user to one of an upright position and a lying down position. Further, as shown in block 350 wherein the determining the change of the position of the user comprises using a camera of the portable electronic device. At block 355, wherein the determining the change of the position of the user comprises using indications received from at least one of the portable electronic device and an ear bud worn by the user and connected to the portable electronic device, the indications based on at least one of a compass and an accelerometer incorporated in at least one of the portable electronic device and the ear bud, and wherein the received indications are used to determine whether there is a corresponding change of the position of the user with respect to the display. Indicated, at block 360, wherein the determining there is not the corresponding change of the position of the user with respect to the display comprises determining a physical arrangement of the display with respect to the user is remaining similar after the change as before the change. At block 370 wherein the determining whether there is a corresponding change of a position of the user of the portable device is performed in response to detecting a movement of the display of the electronic device with respect to gravity.

The embodiments of block 310 and 320 can be combined with any of blocks 330, 340, 350, 355, 360 and 370.

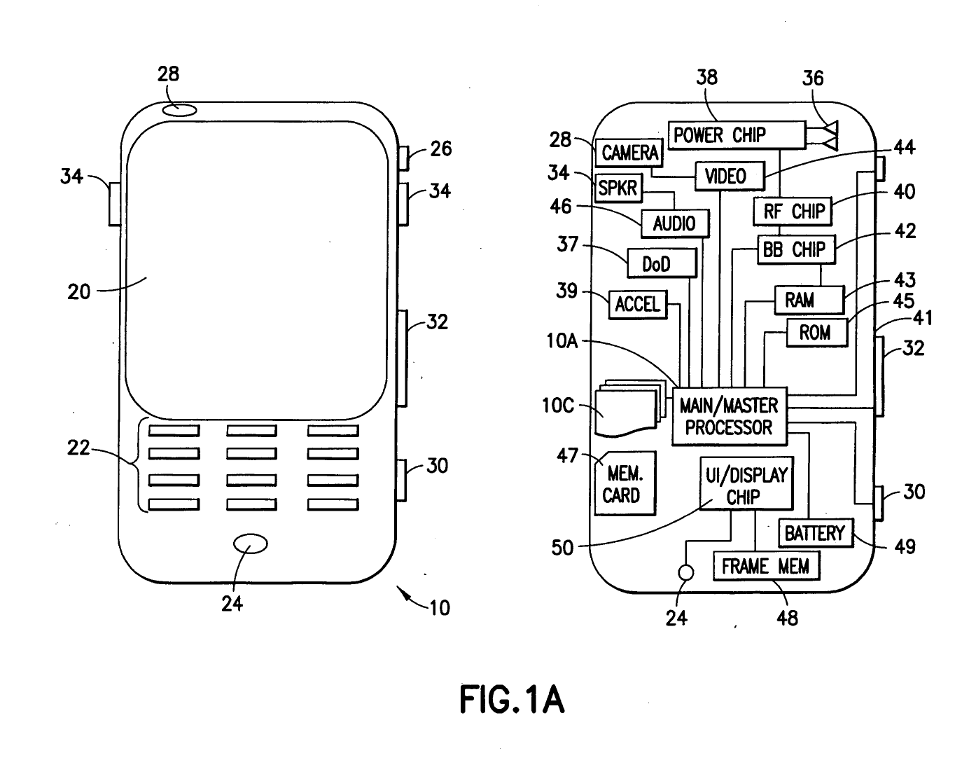

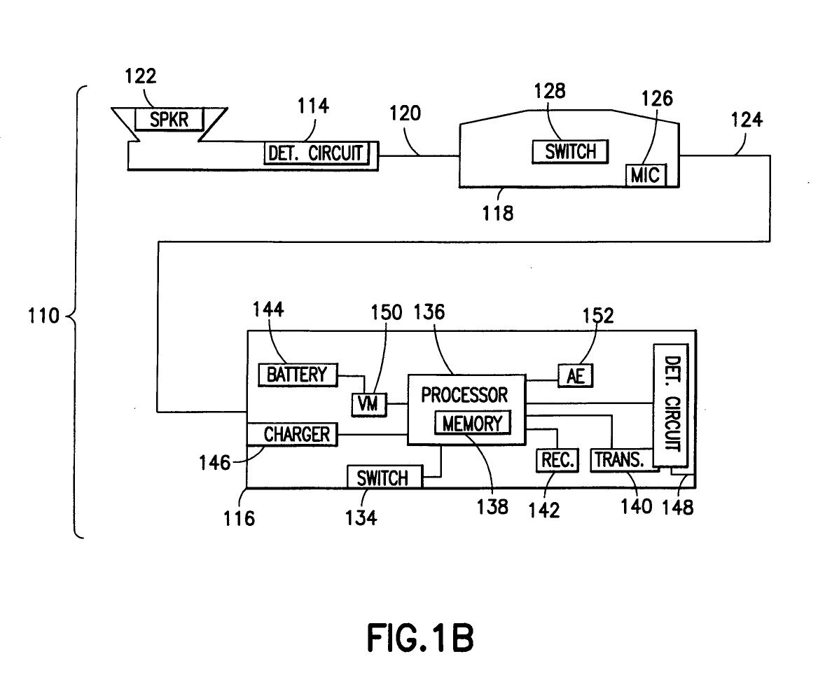

Turning now to FIG. 1A, there is illustrated an exemplary but non-limiting embodiment of a portable electronic device in which aspects of the invention maybe practiced to advantage. The portable electronic device 10 is illustrated at FIG. 1 as a smartphone, which may by size be considered a portable electronic device in which the invention may be embodied. Other exemplary portable electronic devices may or may not include cellular-type radios or any radios at all; such examples including a camera, a digital gaming or music device, a personal digital assistant, a navigation (GPS) device, an internet appliance, and laptop and palmtop personal computers, to name a few.

At FIG. 1A the portable electronic device 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary portable electronic device 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode. Buffering video is one environment in which embodiments of these teachings are expected to prove particularly advantageous.

Within the sectional view of FIG. 1 A are seen multiple transmit/receive antennas 36 that are typically used for cellular or other (e.g., WLAN, Bluetooth, GPS) wireless communications. There is a radio front end illustrated as a power chip 38 disposed on a printed wiring board which may also embody various transmitters and receivers for different radio technologies. Depending on whether transmitting or receiving, the power chip 38 controls power amplification on the channels being transmitted from the antenna(s) 36, and amplifies the received signals which are then output to the radio-frequency (RF) chip 40 that demodulates and downconverts the received signal for baseband processing. The baseband (BB) chip 42 detects the signal which is then converted to a bit-stream and finally decoded.

Signals to and from the camera 28 pass through an image/video processor 44 which encodes and decodes the various image frames. A separate audio processor 46 may also be present to control signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Throughout the apparatus are various memories, by non-limiting example random access memory RAM 43 nonvolatile memory, read only memory ROM 45, one or more embedded memory cards and removable memory such as the illustrated MMC memory card 47. Various computer programs 10C for operating various aspects of the portable electronic device, including computer program instructions for operating according to these teachings, are stored in these various memories. In an embodiment there is a mass memory, such as for example an MMC 47, which includes at least two buffers of different type: one is a volatile memory buffer (such as dynamic RAM or DRAM, and static RAM or SRAM) and the other is a non-volatile memory buffer (such as flash memory, magneto-resistive RAM, and magnetic and optical disc). In other embodiments the different buffers of different memory types need not be co-located on a same chip/module with the mass memory to which the buffered write data is to be written or from where the buffered write data was copied.

In an embodiment the MMC 47 also includes an on-chip processor which controls which of those various buffers is used at any given time for write data, and the on-chip processor may switch which buffer is in use in response to a command received from the main or master processor 10A of the portable electronic device 10. The write data may be buffered for writing to a semi-permanent storage within the mass memory 41, 47, or it maybe buffered to write to some other memory within the portable electronic device 10 such as for example temporary memories associated with storing parameters for operating a radio or some peripheral hardware such as for example the camera and/or graphical display screen 20 for video collection and display purposes. As detailed by non-limiting example below, it is the main/master processor 10A which collects various inputs to assess the reliability of the power supply but in other embodiments the on-chip processor within the mass memory 41, 47 may collect those inputs and make the power supply reliability assessment itself. Embodiments of the invention may be implemented with respect to the embedded memory and/or the removable memory card 47 or other discrete memory modules of the portable electronic device 10. The single portable electronic device 10 may exhibit multiple implementations of the embodiments detailed below, one for each of two or more distinct memory modules or units.

There is also within the portable electronic device 10 a DoD 37 (display information orientation device) 37 whose operations are detailed above in anon-limiting embodiment as a display orientation determination function implemented by stored software, and there is further an accelerometer or gyroscope or compass device (accel) 39 also detailed above. All of these components within the portable electronic device 10 are normally powered by a portable power supply such as a galvanic battery 49.

The aforesaid processors 38, 40, 42, 44, 46, 50, and the on-chip processor within the MMC 47, if embodied as separate entities in the portable electronic device 10, may operate in a slave relationship to the main processor 10A, which may then be in a master relationship to them. Any or all of these various processors of FIG. 1 may access one or more of the various memories or only a limited set of them. Note that the various chips (e.g., 38, 40, 42, etc.) that were described above may be combined into a fewer number than described and, in a most compact case, may all be embodied physically within a single chip having one or more processors 10A. The various processors may be of any type suitable to the local technical environment, and may include one or more of general purpose computers, special purpose computers, microprocessors, digital signal processors (DSPs), processors based on a multicore processor architecture, application specific integrated circuits ASICs, and the specific mass memory (MMC) 47 on-chip processor noted above, as non-limiting examples.

In more general terms the portable electronic device 10 may be considered to include at least one controller, such as a computer or a data processor (DP) 10A or other of the described processors, a memory medium tangibly embodied as a computer readable memory (MEM) that stores a program of computer program code (PROG) 10C, and a MMC 41, removable memory card 47) which may or may not be the same as the memory storing the described computer program code 10C. That is, the computer program code 10C may be stored within the MMC 47 itself and direct operations for how the MMC 47 operates, or the computer program code 10C may reside in some other memory of the portable electronic device 10 apart from the mass memory which the program code 10C controls. Wherever stored, at least one of the PROGs 10C is assumed to include program instructions that, when executed by the associated DP, enable the portable electronic device 10 to operate in accordance with the exemplary embodiments of this invention, as will be discussed above in greater detail. That is, the exemplary embodiments of this invention may be implemented at least in part by stored computer software executable by at least one processor of the portable electronic device 10 or by hardware, or by a combination of stored software and hardware (and/or stored firmware).

Referring now also to FIG. 1B, there is shown a block diagram illustrating various components and/or electronic circuitry of a type of headset. This headset illustrated in FIG. 1B is non-limiting as any headset design can be used in accordance with the invention. The different components depicted in FIG. 1B are for reference, and portions of any of these components may be incorporated into a single headset device. Further, the headset may be wired or wireless. The headset may be considered to include at least one processor 136 and at least one memory 138 including computer program code. The at least one memory 138 and the computer program code are configured to, with the at least one processor 136, cause the apparatus (wireless headset unit) to perform methods comprising embodiments of the invention. The at least one processor 136 may be operatively coupled to the loudspeaker element 122 and the microphone 126 through wires 120, 124. In some embodiments, the at least one processor 136 may be coupled to the switch 134, which is configured to actuate, for example, power on/off state, accepting or terminating call, and/or other functions relating to the wired or wireless headset. Further, a switch 128 may be between the speaker 122 and the secondary unit 116. However, in accordance with the embodiments of the invention the switch 128 may not be present and/or the speaker 122 may be embodied in a device which includes at least some of the components of the secondary unit 116. The headset further comprises a transmitter 140 and a receiver 142, such as a Bluetooth transmitter and a Bluetooth receiver. The wireless headset 110 further comprises a power source, such as a battery 144. In an embodiment, the headset 110 also comprises a charger or charging interface 146 for charging the battery 144. The headset 110 further comprises detection circuits 114 and/or detection circuits 148. The detection circuits are each illustrated as one component but can be several separate components. The detection circuits 114 and 148 can comprise a compass and an accelerometer, each configured to operate in accordance with the exemplary embodiments as described above.

In general, the various embodiments may be implemented in hardware or special purpose circuits, software, logic or any combination thereof For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. A method comprising:
determining, by a portable electronic device, whether there is a corresponding change of a position of a user of the portable electronic device with respect to a display; and
in response to determining there is not a corresponding change of the user with respect to the display, maintaining a display orientation of information on the display.

2. The method according to claim 1, wherein the determining the change of the position of the user comprises determining there is a change of position of at least one of eyes, head, and face of the user with respect to the display.

3. The method according to claim 2, wherein the determining the change of the position of the user comprises determining a change of the position of the user to one of an upright position and a lying down position.

4. The method according to claim 1, wherein the determining the change of the position of the user comprises using a camera of the portable electronic device.

5. The method according to claim 1, wherein the determining the change of the position of the user comprises using indications received from at least one of the portable electronic device and an ear bud worn connected to the portable electronic device, the indications based on at least one of a compass and an accelerometer incorporated in at least one of the portable electronic device and the ear bud, and wherein the received indications are used to determine whether there is a corresponding change of the position of the user with respect to the display.

6. The method according to claim 1, wherein the determining there is not the corresponding change of the position of the user with respect to the display comprises determining a physical arrangement of the display with respect to the user is remaining similar after the change as before the change.

7. The method according to claim 1, wherein the determining whether there is a corresponding change of a position of the user of the portable device is performed in response to detecting a movement of the display of the electronic device with respect to gravity

8. The method according to claim 1 performed by computer program code embodied on a computer readable memory and executed by at least one processor.

9. An apparatus comprising:
at least one processor; and
at least one memory including computer program code, where the at least one memory and the computer program code are configured, with the at least one processor, to cause the apparatus, to at least:
determine, by a portable electronic device, whether there is a corresponding change of a position of a user of the portable electronic device with respect to a display; and
in response to determining there is not a corresponding change of the user with respect to the display, maintain a display orientation of information on the display.

10. The apparatus according to claim 9, wherein the determining the change of the position of the user comprises the at least one memory including the computer program code is configured, with the at least one processor, to cause the apparatus to determine there is a change of position of at least one of eyes, head, and face of the user.

11. The apparatus according to claim 9, wherein the determining the change of the position of the user comprises the at least one memory including the computer program code is configured, with the at least one processor, to cause the apparatus to determine a change of the position of the user to one of an upright position and a lying down position.

12. The apparatus according to claim 9, wherein the at least one memory including the computer program code is configured, with the at least one processor, to cause the apparatus to use a camera of the portable electronic device to determine the change of the position of the user.

13. The apparatus according to claim 9, wherein the at least one memory including the computer program code is configured, with the at least one processor, to cause the apparatus to use indications received from at least one of the portable electronic device and an ear bud worn connected to the portable electronic device to determine the change of the position of the user, wherein the indications are based on at least one of a compass and an accelerometer incorporated in at least one of the portable electronic device and the ear bud, and wherein the indications are used to determine whether there is a corresponding change of the position of the user with respect to the display.

14. The apparatus according to claim 9, wherein the determining there is not the corresponding change of the position of the user with respect to the display comprises the at least one memory including the computer program code is configured, with the at least one processor, to cause the apparatus to determine a physical arrangement of the display with respect to the user is remaining similar after the change as before the change.

15. The apparatus according to claim 9, wherein the determining whether there is a corresponding change of a position of the user of the portable device is performed in response to detecting a movement of the display of the electronic device with respect to gravity.

16. An apparatus comprising:
means for determining, by a portable electronic device, whether there is a corresponding change of a position of a user of the portable electronic device with respect to the display; and
means, in response to the determining indicating there is not a corresponding change of the position of the user with respect to the display, for maintaining a display orientation of information on the display.

17. The apparatus of claim 16, where the means for determining comprises the at least one memory including computer program code and at least one processor executing the at least one computer program code.
